(19) United States
(12) Patent Application Publication
(10) Pub. No.: US 2017/0089305 A1
(43) Pub. Date: Mar. 30, 2017

(54) CANISTER APPARATUS FOR VEHICLE

(71) Applicants: Hyundai Motor Company, Seoul (KR); Kia Motors Corporation, Seoul (KR)

(72) Inventor: Jang Hyun Jung, Suwon (KR)

(21) Appl. No.: 14/982,694

(22) Filed: Dec. 29, 2015

(30) Foreign Application Priority Data
Sep. 24, 2015 (KR) 10-2015-0135233

(51) Int. Cl. F02M 25/08

(52) U.S. Cl. CPC F02M 25/0854

(57) ABSTRACT

A canister apparatus for a vehicle is provided. The apparatus reduces noise of a canister by utilizing an air gap disposed in the canister, and partition walls, which are disposed at predetermined positions in the air gap space in the canister. As a result, vehicle NVH characteristics are improved and the discharge amount of bleed emission that causes environmental pollution is reduced.

### CROSS-REFERENCE TO RELATED APPLICATION

This application claims under 35 U.S.C. §119 a the benefit of Korean Patent Application No. 10-2015-0135233 filed on Sep. 24, 2015, the entire contents of which are incorporated herein by reference.

BACKGROUND

(a) Technical Field

The present disclosure relates to a canister apparatus for a vehicle, and more particularly, to a canister apparatus for a vehicle, which reduces noise of a canister by utilizing an air gap configured in the canister.

(b) Background Art

In general, a canister is a device used to discharge air contained in vaporized fuel gas generated in a fuel tank into the atmosphere, and is configured to collect and supply a fuel component to an engine. The canister is typically mounted within a vehicle to prevent a loss of fuel vaporized in the fuel tank and prevent the vaporized fuel gas from being discharged into the atmosphere by supplying a fuel component, which is collected when the engine is normally operated (e.g., operated without failure), to the engine.

The attached FIG. 1 is a view illustrating an operation of a typical canister according to the related art. Referring to FIG. 1, a canister 3 for collecting vaporized fuel gas is installed between a fuel tank 1 and an engine 2, and a purge control solenoid valve (PCSV) 4, which is connected with the canister 3, is installed to adjust vaporized fuel gas collected by the canister 3. The purge control solenoid valve (PCSV) supplies the vaporized fuel gas collected by the canister to the engine by receiving a signal from an electronic control unit (ECU).

In other words, by the PCSV, the vaporized fuel gas collected by the canister is not supplied to the engine before the engine warms up or when the engine idles, but during a normal operation in which the engine completes warming-up and a predetermined load is applied, the vaporized fuel gas is supplied to the engine, and then combusted in the engine. The canister includes active carbon with high adsorptive force to collect vaporized fuel gas therein, and the canister collects vaporized fuel gas generated in the fuel tank, and separates the vaporized fuel gas into a fuel component and air. The air is discharged into the atmosphere, and the fuel component is supplied into an intake pipe by negative pressure in the intake pipe of the engine when the PCSV is opened.

However, pulsation noise, which occurs when the PCSV is operated, is transmitted through a fuel line and amplified in the canister, and as a result, vehicle NVH characteristics deteriorate. Accordingly, to solve the deterioration in the NVH characteristics, a pulsation chamber, which operates as a damper, is added to the fuel line connected to the canister. However, when performance of the PCSV is changed, pulsation noise increases, and thus, the deterioration in the NVH characteristics may not be solved by the single pulsation chamber.

Therefore, an installation of an additional pulsation chamber is further required later to cope with the change in performance of the PCSV, and as a result, a size and cost are inevitably increased.

The above information disclosed in this section is merely for enhancement of understanding the background of the invention and therefore it may contain information that does not form the prior art that is already known in this country to a person of ordinary skill in the art.

### SUMMARY

The present invention provides a canister apparatus for a vehicle, capable of reducing noise of a canister and reducing bleed emission, which causes environmental pollution, by utilizing an air gap configured in the canister.

In one aspect, the present invention provides a canister apparatus for a vehicle, in which a first partition wall and a second partition wall may be installed at a predetermined interval in a flow direction of gas in an air gap space disposed in a canister body. The first and second partition walls may be disposed at predetermined positions in the air gap space, and a section of frequency, where noise is filtered, may be determined based on the positions of the first partition wall and the second partition wall.

In addition, a gas may flow from one end to the other end of the air gap space. The first partition wall and the second partition wall may be installed to form a predetermined angle with respect to a flow direction of gas flowing into the air gap space, and specifically, the first partition wall and the second partition wall may be installed to form a right angle with respect to a movement direction of gas flowing into the air gap space. Further, a vent aperture and a vent pipe for a gas flow may be formed on at least one of the first partition wall and the second partition wall. A gas diffusing aperture for diffusing gas passing through the vent pipe may be formed in the vent pipe, and, the vent pipes formed on the first partition wall and the second partition wall may be formed opposing each other (e.g., facing away from each other).

According to the canister apparatus for a vehicle according to the present invention, the partition walls, disposed at predetermined positions in the air gap space in the canister, may be installed, thereby improving the vehicle NVH characteristics, and reducing the discharge amount of bleed emission that causes environmental pollution. Therefore, it may be possible to eliminate the existing pulsation chamber configured in the fuel line connected to the canister, reduce costs accordingly, and expect an effect of increasing a size of the pulsation chamber by utilizing a space several times greater than the existing pulsation chamber.

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIG. 1 is a view illustrating an operation of a typical canister according to the related art;

FIGS. 2 and 3 are views illustrating a canister according to an exemplary embodiment of the present invention;

FIGS. 4 and 5 are a longitudinal cross-sectional view and a transverse cross-sectional view of the canister according to the exemplary embodiment of the present invention; and

FIG. 6 is a view illustrating a noise reduction principle for the canister according to the present invention.

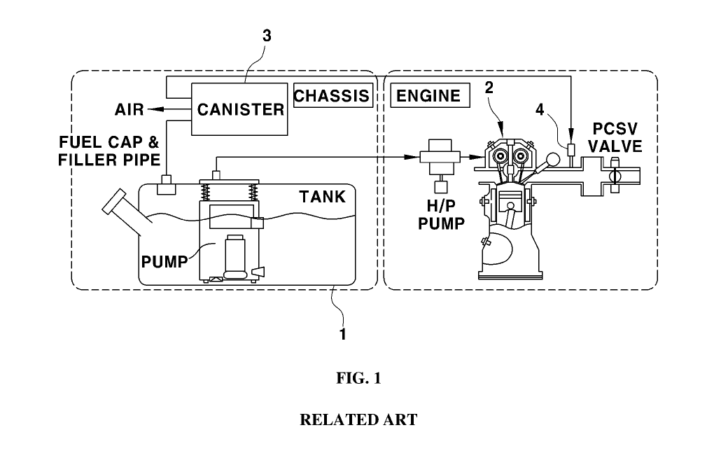

Reference numerals set forth in the Drawings include reference to the following elements as further discussed below:

100: canister body

110: first active carbon filling space

120: second active carbon filling space

130: auxiliary canister

140: air gap space

150: first partition wall

152: vent aperture

154: vent pipe

155: gas diffusing aperture

160: second partition wall

162: vent aperture

164: vent pipe

165: gas diffusing aperture

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 32%, 1%, 0.5%, 0.1%, 0.05%, or 0.01% of the stated value. Unless otherwise clear from the context, all numerical values provided herein are modified by the term “about.”

Hereinafter, reference will now be made in detail to various exemplary embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described in detail with reference to the accompanying drawings.

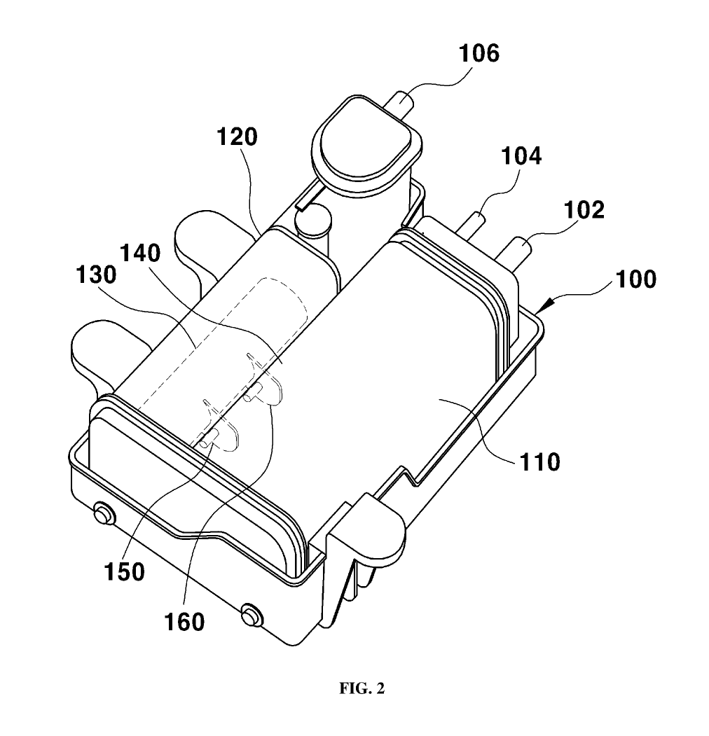

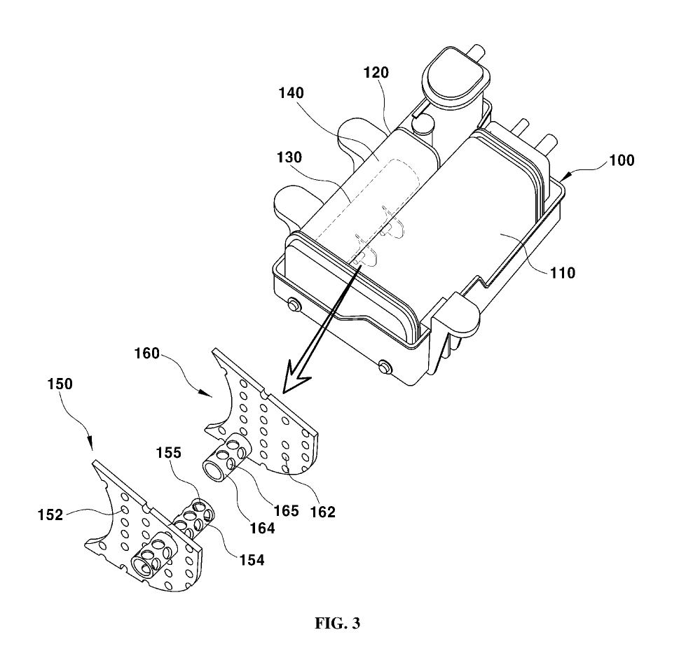

A canister according to an exemplary embodiment of the present invention operates to collect vaporized fuel gas in a fuel tank, discharge air into the atmosphere, and supply a fuel component to an engine. Referring to FIGS. 2 and 3, at one side (e.g., a first side) of a canister body 100 having an internal space, a vaporized gas inlet portion 102 into which vaporized fuel gas flows, a fuel discharge and supply portion 104 from which the fuel component collected from the vaporized fuel gas is discharged, and an air discharge portion 106 from which air separated from the vaporized fuel gas is discharged may be formed.

The vaporized gas inlet portion 102 may be connected to the aforementioned fuel tank, the fuel discharge and supply portion 104 may be connected to the engine through the above-described purge control solenoid valve (PCSV), and the air discharge portion 106 may be configured to discharge air into the atmosphere. The inside of the canister body 100 maybe filled with active carbon to more easily collect the fuel component, and accordingly, the space, filled with active carbon, may be separated into a first active carbon filling space 110 and a second active carbon filling space 120. The first active carbon filling space 110 may be connected with the vaporized gas inlet portion 102 to allow gas to flow therebetween, and the second active carbon filling space 120 may be connected with the first active carbon filling space 110 through an air gap space 140 to allow gas to flow therebetween.

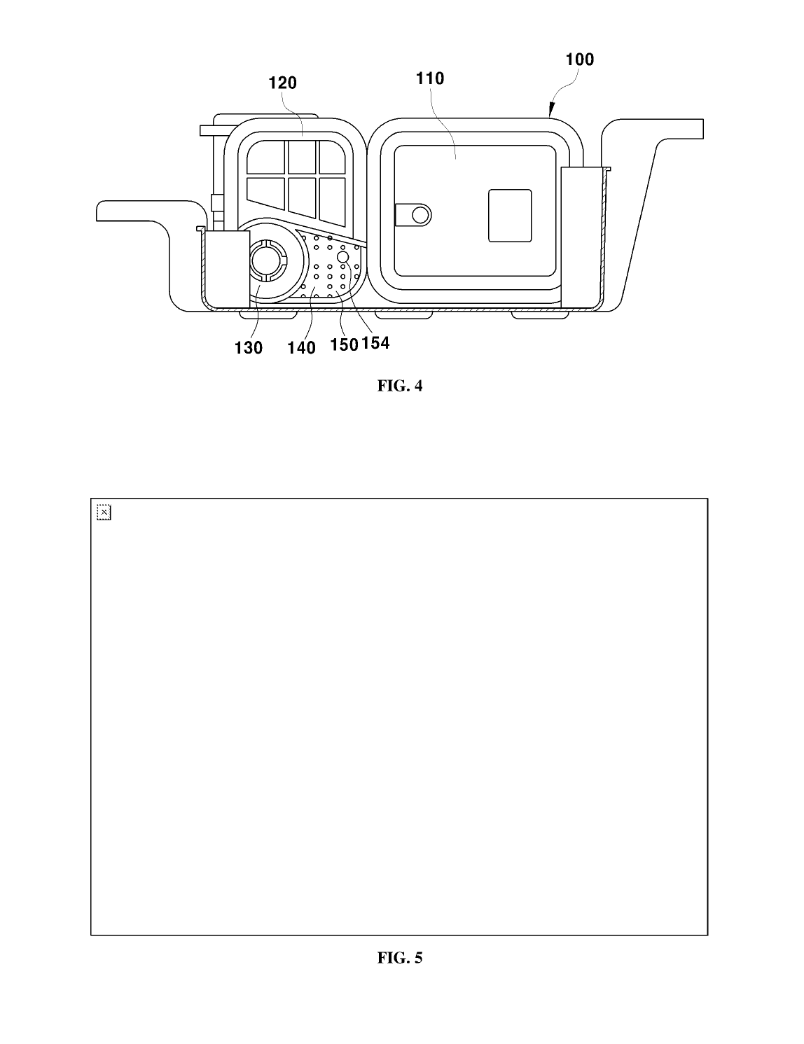

Referring to FIG. 4, the air gap space 140 may be a vacant space that is not filled with the active carbon, and may be formed to be adjacent to an auxiliary canister 130 installed in the second active carbon filling space 120, and disposed at a position surrounded by the first active carbon filling space 110, the second active carbon filling space 120, and the auxiliary canister 130. In other words, the air gap space 140 may be a vacant space that is not filled with active carbon in the second active carbon filling space 120, and a first partition wall 150 and a second partition wall 160 may be installed to apply a gas flow closing shape or an air flow closing shape to an air gap space 140.

Referring to FIGS. 4 and 5, the first partition wall 150 and the second partition wall 160 may be provided in the form of a panel that may separate the air gap space 140 in the gas flow direction, respectively, and as a portion of the canister body 100, the first partition wall 150 and the second partition wall 160 have shapes that may come into close contact with (e.g., abut) the canister body 100 and the auxiliary canister 130 that surround the second active carbon filling space 120.

In particular, the first and second partition walls 150 and 160 may be installed at a predetermined interval in a flow direction of gas flowing into the air gap space 140, and particularly, the first and second partition walls 150 and 160 may be disposed at predetermined positions in the air gap space 140, to set a section of wavelength where noise (e.g., pulsation noise) is filtered based on the position of the partition walls. Furthermore, an emission damper space may be formed to reduce an emission amount discharged to the exterior.

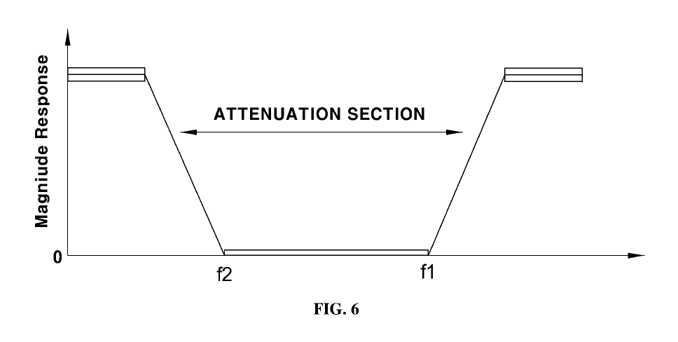

The setting of the section of wavelength, where the noise is filtered based on positions of the partition walls, may be performed by a principle of band stop filter as illustrated in FIG. 6, and the section of wavelength, where noise (pulsation noise) is filtered, may be determined based on predetermined positions of the partition walls 150 and 160, and with a principle that the wavelength is related to the frequency, and the section of frequency, where noise will be filtered may be determined For example, noise may be reduced with respect to a frequency section of about 100 Hz to 400 Hz based on the positions of the partition walls, and at the entirety of the frequency section (e.g., about 100 Hz to 400 Hz) determined based on the positions of the partition walls in the air gap space 140, noise may be reduced. In particular, a frequency section may be determined using the equation v=f×(λ) which is based on the positions of the partition walls (λ). Here, the v is fixed to a constant value as the velocity of sound of the air gap space 140, that is, the velocity of sound in the air, and the v is a value obtained by adding the length of a vapor line, which corresponds to a distance of fluid movement from the fuel discharge and supply portion 104 to the engine, a distance from the fuel discharge and supply portion 104 to the air gap space 140 inside the canister body 100, and a distance from the front end of the air gap space 140 to the first partition wall 150 or the second partition wall 160. Accordingly, the f, which indicates frequency, is determined by the value of λ.

In addition, the air gap space 140 may be formed as a gas flow occurs (e.g., as the gas flows) from a first end (into which gas flows) to a second end (from which gas is discharged), and referring to FIG. 5, the first and second partition walls 150 and 160 may be installed to form a predetermined angle with respect to a flow direction of the gas flowing into the air gap space 140. For example, the first and second partition walls 150 and 160 may be installed to form a right angle (e.g., about 90 degree angle) with respect to a movement direction of the gas flowing into the air gap space 140.

When the gas flow closing shape is applied to the air gap space 140 using the first partition wall 150 and the second partition wall 160, performance in terms of a reduction in noise of the canister may be improved, but venting resistance may increase, and thus, a purge rate of the vaporized fuel gas purged to the engine may be reduced. Since vehicle power performance may be reduced when the purge rate is reduced, an optimal flow path for reducing venting resistance may be set. Therefore, to form a gas flow path for reducing venting resistance, a plurality of vent apertures 152 and 162 for a gas flow may be formed in at least one of the first partition wall 150 and the second partition wall 160 installed in the air gap space 140.

The plurality of vent apertures 152 and 162 may be formed by changing a condition such as the size and the interval thereof, and as illustrated in FIGS. 3 and 4, the plurality of vent apertures 152 and 162 may be formed to be arranged in a row in the transverse direction and the longitudinal direction, and may have about the same size. In addition, vent pipes 154 and 164 through which a substantial amount of gas may flow compared to the vent apertures 152 and 162 may be formed on at least one of the first partition wall 150 and the second partition wall 160.

The vent pipes 154 and 164 may be pipes having a predetermined diameter, formed in the form of a pipe that penetrates the partition wall. For example, the venting pipes 154 and 164 may be penetratively attached to or formed integrally with the partition walls to cause an axial direction to form a right angle with the partition walls 150 and 160. Further, to diffuse gas passing through the vent pipes 154 and 164, particularly, to more smoothly diffuse gas, which passes through the vent pipes 154 and 164 and then flows into the space between the first partition wall 150 and the second partition wall 160, adjacent to each other at a predetermined interval, the vent pipes 154 and 164 formed on the respective partition walls 150 and 160 may be formed at positions where the vent pipes 154 and 164 do not face each other in the upward and downward direction and in the left and right direction (e.g., vertically and horizontally) with respect to the partition walls 150 and 160. In other words, the vent pipes 154 and 164 may be formed to oppose each other.

For example, as illustrated in FIGS. 3 and 5, any one vent pipe of the two vent pipes 154 and 164 formed on the first partition wall 150 and the second partition wall 160 may be formed at a left lower side of the partition wall (e.g., a partition wall disposed relatively forward), and the other vent pipe may be formed at a right upper side of the other partition wall (e.g., a partition wall disposed relatively rearward), and thus, the two vent pipes 154 and 164 may be disposed to be misaligned in a diagonal direction. Thus, a first pipe may be formed in at a first position and a second pipe may be formed at a second position that opposes the first position. In addition, to more smoothly diffuse gas, which passes through the vent pipes 154 and 164 and then flows into a space between the first partition wall 150 and the second partition wall 160, a plurality of gas diffusing apertures 155 and 165 may be formed in an outer circumferential surface of the vent pipes 154 and 164 in a circumferential direction and in an axial direction.

As described above, the gas flow closing shape, which may reduce an emission damper space and venting resistance for reducing the amount of emission discharged to the exterior by utilizing the air gap space 140 in the canister body 100, may be applied, to form a structure for bleed emission diffusion prevention and a resonator structure in the canister, thereby improving NVH performance, and to reduce the discharge amount of bleed emission discharged to the exterior. To increase the amount of fuel components collected from the vaporized fuel gas, the aforementioned auxiliary canister 130 may be additionally installed in the canister body 100, and configured to collect the fuel component from the vaporized fuel gas using a honeycomb structure.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A canister apparatus for a vehicle, comprising:
a first partition wall and a second partition wall installed at a predetermined interval in a flow direction of gas that flows in an air gap space disposed in a canister body,
wherein the first and second partition walls are disposed at predetermined positions in the air gap space.

2. The canister apparatus of claim 1, wherein a section of frequency, where noise is filtered, is determined based on the positions of the first partition wall and the second partition wall.

3. The canister apparatus of claim 1, wherein a gas flow occurs from a first end to a second end of the air gap space.

4. The canister apparatus of claim 1, wherein the first partition wall and the second partition wall are installed to form a predetermined angle with respect to a flow direction of gas flowing into the air gap space.

5. The canister apparatus of claim 1, wherein the first partition wall and the second partition wall are installed to form a right angle with respect to a movement direction of gas flowing into the air gap space.

6. The canister apparatus of claim 1, wherein a vent aperture for a gas flow is formed in at least one of the first partition wall and the second partition wall.

7. The canister apparatus of claim 1, wherein a vent pipe for a gas flow is formed in at least one of the first partition wall and the second partition wall.

8. The canister apparatus of claim 7, wherein a gas diffusing aperture for diffusing gas passing through the vent pipe is formed in the vent pipe.

9. The canister apparatus of claim 7, wherein the vent pipes formed on the first partition wall and the second partition wall are formed to oppose each other.

10. The canister apparatus of claim 6, wherein a plurality of vent apertures are formed to be arranged in a row in a transverse direction and a longitudinal direction, and have about the same size.
